(19) United States
(12) Patent Application Publication
(10) Pub. No.: US 2012/0232202 A1
(43) Pub. Date: Sep. 13, 2012

(54) Cross-Linkable Silicone Composition, Emulsion Thereof And Method Of Manufactering

(76) Inventor: Yoshitsugu Morita, Ichihara-shi (JP)

(21) Appl. No.: 13/395,523

(22) PCT Filed: Sep. 14, 2010
(86) PCT No.: PCT/JP2010/066277

§ 371 Date: May 24, 2012

(30) Foreign Application Priority Data
Sep. 14, 2009 (JP) JP2009-212462

(51) Int. Cl. C08L 83/04; C08K 5/5419; C08K 3/20

(52) U.S. Cl. 524/268

(57) ABSTRACT

An emulsion of a silicone oil that contains cross-linked silicone particles in droplets of a silicone oil which are dispersed in water, wherein the aforementioned silicone oil is an organopolysiloxane having in its molecule at least two alkenyl groups, and wherein the cross-linked silicone particles are formed by a hydrosilation reaction; and a cross-linkable silicone composition comprising (I) a silicone composition obtained by removing water from the aforementioned emulsion, (II) an organopolysiloxane that contains in its molecule at least two silicon-bonded hydrogen atoms; and (III) a hydrosilation catalyst.

### TECHNICAL FIELD

This invention relates to a silicone oil emulsion that contains cross-linked silicone particles in silicone oil drops which are dispersed in water. The invention also relates to a manufacturing method of the aforementioned emulsion and to a cross-linkable silicone composition comprising a silicone oil composition obtained by removing water from the aforementioned emulsion as a main component.

### BACKGROUND ART

Patent References No. 1 to 3 disclose a silicone oil emulsion that contains cross-linked silicone particles in silicone oil drops which are dispersed in water, and a method of manufacturing the aforementioned emulsion by cross-linking in water a cross-linkable silicone composition that contains a silicone oil, which does not participate in the cross-linking reaction (hereinafter referred to as “non-cross-linkable oil”), in an amount greater than that just needed to keep the cross-linked silicone particles dispersed in the cross-linked product. More specifically, when the cross-linkable silicone composition is cross-linked by a hydrosilylation reaction, the non-cross-linkable oil may be exemplified by a dimethylpolysiloxane having both molecular terminals capped with trimethylsiloxy groups, a methylphenylpolysiloxane having molecular terminals capped with trimethylsiloxy groups, a copolymer of a methylphenylpolysiloxane and a dimethylsiloxane having molecular terminals capped with trimethylsiloxy groups, or a cyclic dimethylsiloxane.

However, although Patent References No. 1 to No. 3 describe a silicone oil emulsion that contains cross-linked silicone particles in silicone oil drops which are dispersed in water and that the cross-linked silicone particles are formed from a silicone composition cross-linkable by a hydrosilation reaction, these References do not teach that the emulsion can be made from a silicone oil such as a dimethylpolysiloxane capped at both molecular terminals with dimethylvinylsiloxy groups, a copolymer of a dimethylsiloxane and a methylvinylsiloxane capped at both molecular terminals with trimethylsiloxy groups, or a similar silicone oil that contains alkenyl groups in its molecule.

On the other hand, Patent References No. 4 and 5 state that when a suspension of cross-linked silicone particles is prepared by cross-linking a hydrosilation-curable silicone composition in water, the aforementioned cross-linkable silicone composition may comprise an organopolysiloxane having in its molecule at least two alkenyl groups, an organopolysiloxane having in its molecule at least two silicon-bonded hydrogen atoms, and a hydrosilation catalyst, wherein the organopolysiloxane having silicon-bonded hydrogen atoms is added in an amount based on 0.5 to 20 hydrogen atoms per one alkenyl group in the alkenyl-containing organopolysiloxane. This is because when the content of the aforementioned organopolysiloxane is smaller than the lower recommended limit, the obtained composition will not be sufficiently cured.
[Patent Reference 1] JP 2000-281523 A
[Patent Reference 2] JP 2000-281903 A
[Patent Reference 3] JP 2002-249588 A
[Patent Reference 4] JP 63-257939 A

### DISCLOSURE OF INVENTION

### Technical Problems to be Solved

It is an object of the present invention to provide an emulsion, which can be used as a starting material for preparation of a hydrosilation-curable silicone composition and which comprises silicone particles and an organopolysiloxane having in its molecule at least two alkenyl groups; an efficient manufacturing method of said emulsion and cross-linkable silicone composition which contains the uniformly-dispersed cross-linked silicone particles.

### Solution to Problems

The emulsion of the present invention is an emulsion of a silicone oil that contains cross-linked silicone particles in drops of a silicone oil which are dispersed in water and have an average diameter in the range of 0.1 to 500 μm, the aforementioned silicone oil being an organopolysiloxane having in its molecule at least two alkenyl groups, the aforementioned cross-linked silicone particles being formed by a hydrosilation reaction.

The method of the invention for preparation of an emulsion of a silicone oil that contains silicone oil particles in silicone oil drops distributed in water and having an average diameter in the range of 0.1 to 500 μm comprises the steps of: subjecting an organopolysiloxane (A) having in its molecule at least two alkenyl groups and an organopolysiloxane (B) having in its molecule at least two silicon-bonded hydrogen atoms to a hydrosilation reaction in the presence of a hydrosilation catalyst (C), the silicon-bonded hydrogen atoms of component (B) being used in an amount of 0.05 to 0.3 moles per one mole of alkenyl groups contained in component (A).

The cross-linkable silicone composition of the invention comprises at least the following components:

(I) 100 parts by mass of a silicone composition obtained by removing water from an emulsion of a silicone oil that contains cross-linked silicone particles in drops of a silicone oil which are dispersed in water and have an average diameter in the range of 0.1 to 500 μm, the aforementioned silicone oil comprising an organopolysiloxane containing in its molecule alkenyl groups, the cross-linked silicone particles being obtained by a hydrosilation reaction;

(II) 0.1 to 500 parts by mass of an organopolysiloxane that contains in its molecule at least two silicon-bonded hydrogen atoms; and

(III) a catalytic quantity of a hydrosilation catalyst.

### Advantageous Effects of Invention

The emulsion of the invention can be used as a starting material for the preparation of a hydrosilation-curable silicone composition and is characterized by the fact that the silicone oil composition consists of cross-linked silicone particles and an organopolysiloxane that contains in one molecule at least two alkenyl groups. The method of the invention is characterized by efficiently producing the aforementioned emulsion, and the cross-linked silicon composition of the invention is characterized by producing a cross-linked silicon materials which cross-linked silicon particles uniformly dispersed in.

### BEST MODE FOR CARRYING OUT THE INVENTION

First, the emulsion of the invention is described in more detail. The silicone oil, which forms, in the emulsion of the invention, silicone oil drops dispersed in water, is comprises organopolysiloxane that contains in its molecule at least two alkenyl groups. These alkenyl groups can be exemplified by vinyl, benzyl, butenyl, and hexenyl groups; the vinyl and hexenyl groups are preferable. Organic silicon-bonded groups other than alkenyl groups can be represented by methyl, ethyl, propyl, or similar alkyl groups; phenyl, tolyl, xylyl, or similar aryl groups; benzyl, phenethyl, or similar aralkyl groups; 3,3,3-trifluoropropyl, or other halogenated alkyl groups. Methyl and phenyl groups are preferable. There are no special limitations with regard to the molecular structure of the aforementioned organopolysiloxane, and the organopolysiloxane may have a completely linear, partially-branched linear, cyclic, or a branched-chain molecular structure. A linear molecular structure is most preferable. There are no special limitations with regard to viscosity of the organopolysiloxane at 25° C. It is preferred that the viscosity is in the range of 1 to 100,000,000 mPa·s, more preferably 2 to 10,000,000 mPa·s.

The organopolysiloxane may be exemplified by a dimethylpolysiloxane having both molecular terminals capped with dimethylvinylsiloxy groups, a copolymer of methylvinylsiloxane and dimethylsiloxane having dimethylvinylsiloxy groups on both molecular terminals, a copolymer of a methylphenylsiloxane and a dimethylsiloxane having dimethylvinylsiloxy groups at both molecular terminals, a methylvinylpolysiloxane having trimethylsiloxy groups at both molecular terminals, a copolymer of a methylvinylsiloxane and a dimethylsiloxane having trimethylsiloxy groups at both molecular terminals, and a cyclic methylvinylpolysiloxane.

The average diameter of silicone oil drops in the emulsion of the present invention should be within the range of 0.1 to 500 μm, preferably within the range of 0.5 to 200 μm. This is because it is difficult to prepare the emulsion with an average diameter of drops below the lower limit of the above range. On the other hand, an emulsion with an average diameter of drops greater than the upper limit of the above range will have low stability.

The cross-linked silicone particles contained in the emulsion of the present invention are obtained by a hydrosilation reaction. Because the cross-linked silicone particles is contained in the silicone-oil drops which are dispersed in water, the diameter of the cross-linked silicone particles should be smaller than that of the silicone oil droplets in water. More specifically, the cross-linked silicone particles should have an average diameter in the range of 0.1 to 100 μm, and preferably, 0.5 to 50 μm. If the particles are smaller than the lower limit of the range, they will be difficult to form, and if, on the other hand, they exceed the upper limit of the range, the emulsion that contains such cross-linked silicone particles will become unstable. The cross-linked silicone particles may have a spherical, thread-like, flat, or irregular shape. The spherical shape is preferable.

Although there are no special limitations with regard to amount of water in the emulsion, it is preferred that water be used in an amount of 5 to 99 mass %, and preferably 10 to 80 mass % based upon the total weight of the emulsion.

If it is desired to improve the stability of the emulsion, the emulsion can be combined with a nonionic surfactant, a cationic surfactant, or an anionic surfactant. The most preferable surfactant is a nonionic one. It is recommended that the surfactants should be used in an amount of 0.1 to 20 parts by weight, preferably 0.5 to 10 parts by weight per 100 parts by weight to the total amount of the cross-linked silicone particles and the silicone oil.

The following is a more detailed description of the manufacturing method of the emulsion of the invention.

The cross-linkable silicone composition produced by the method of the present invention comprises at least the following components: an organopolysiloxane (A) that contains in one molecule at least two alkenyl groups; an organopolysiloxane (B) that contains in one molecule at least two hydrogen atoms; and a hydrosilation catalyst (C).

Alkenyl groups contained in component (A) are represented by vinyl groups, allyl groups, butenyl groups, and hexenyl groups, of which the most preferable are vinyl and hexenyl groups. Silicon-bonded organic groups other than alkenyl groups contained in component (A) are represented by methyl groups, ethyl groups, propyl groups, or similar alkyl groups; phenyl groups, tolyl groups, xylyl groups, or similar aryl groups; benzyl groups, phenethyl groups, or similar aralkyl groups; 3,3,3-trifluoropropyl groups, or similar halogenated hydrocarbon groups. The methyl and phenyl groups are preferable. Component (A) may have a linear, cyclic, net-like, or partially-branched linear molecular structure. In order to form elastomer-like cross-linked silicone particles, the linear and partially-branched linear structures are preferable. Although there are no special limitations with regard to the viscosity of the component (A) provided that it is liquid at 25° C., it is preferred that the viscosity be within a range of 20 to 100,000 mPa·s, preferably between 20 and 10,000 mPa·s.

Silicon-bonded organic groups other than hydrogen atoms of component (B) are represented by methyl groups, ethyl groups, propyl groups, or similar alkyl groups; phenyl groups, tolyl groups, xylyl groups, or similar aryl groups; benzyl groups, phenethyl groups, or similar aralkyl groups; 3,3,3-trifluoropropyl groups, or similar halogenated hydrocarbon groups. The methyl and phenyl groups are preferable. Component (B) may have a linear, cyclic, net-like, or partially-branched linear molecular structure. Although there are no special limitations with regard to the viscosity of the component (B) provided that it is liquid at 25° C., it is preferred that the viscosity be within a range of 1 to 10,000 mPa·s.

In this manufacturing method, in order to prepare an emulsion of a silicone oil that contains cross-linked silicone particles in silicone-oil drops dispersed in water, component (B) should be used in such an amount that the content of silicon-bonded hydrogen atoms in this component is in the range of 0.05 moles to 0.3 moles, preferably in the range of 0.05 moles to 0.2 moles, per one mole of alkenyl groups contained in component (A). If the content of component (B) is below the recommended lower limit, it will be difficult to form silicone particles in the silicone oil. If, on the other hand, the content of component (B) exceeds the recommended upper limit, the cross-linkable silicone composition will be uniformly cross-linked and the particles will be formed as cross-linked silicone gel particles. That will make it impossible to form a silicone oil emulsion.

Component (C) is a hydrosilation catalyst that is used for accelerating hydrosilation of components (A) and (B). This catalyst can be exemplified by a platinum-type catalyst, rhodium-type catalyst, and a palladium-type catalyst, of which the platinum-type catalyst is preferable. Such a platinum-type catalyst is represented by chloroplatinic acid, an alcoholic solution of chloroplatinic acid, an olefin complex of platinum, an alkenylsiloxane complex of platinum, platinum black, or silica that carries platinum.

The method of the present invention can be carried out by dispersing in water the cross-linkable silicone composition which has been premixed with component (C), or the cross-linkable silicone composition can be dispersed in water without component (C), and then emulsion of component (C) can be added to the aqueous dispersion. When the emulsion is formed with premixed component (C), it is preferred to have the average particle diameter of component (C) not exceeding 1 μm.

It is preferred that component (C) be used in an amount sufficient for accelerating the hydrosilation reaction of components (A) and (B). For example, when a platinum-type catalyst is used as component (C), it should be used in an amount of 1×10⁻⁷ to 1×10⁻³ parts by mass of platinum metal per 100 parts by weight of the sum of components (A) and (B).

Fillers can be added to the cross-linkable silicone composition as an arbitrary component, either for adjusting its flowability or for improving the mechanical strength of the obtained cross-linked silicone particles. Examples of such a filler are precipitated silica, fumed silica, baked silica, fumed titanium oxide, or a similar reinforcing filler; crushed quartz, diatomaceous earth, aluminosilicic acid, ferrous oxide, zinc oxide, calcium oxide, or a similar non-reinforcing filler. The surfaces of these fillers can be treated with hexamethylsilazane, trimethylchlorosilane, polydimethylsiloxane, polymethylhydridosiloxane, or similar organosilicon compounds.

There are no special limitations with regard to the amount of water used in the method. It is preferred, however, that water be used in an amount of 5 to 99 wt. %, preferably 10 to 80 wt. % based upon the total weight of the emulsion.

If it is desired to disperse the cross-linkable silicone composition in water with good temporal stability in this manufacturing method, the composition can be combined with a nonionic surfactant, a cationic surfactant, or an anionic surfactant. The most preferable surfactant is a nonionic one. It is recommended that the surfactant should be used in an amount of 0.1 to 20 parts by mass, preferably 0.5 to 10 parts by mass per 100 parts by mass of the cross-linkable silicone composition.

The method of the invention is characterized by dispersing a cross-linkable silicone composition that contains at least aforementioned components (A) through (C) in water and then conducting a hydrosilation reaction. Dispersing the cross-linkable silicone composition in water can be carried out with the use of a homomixer, paddle mixer, Henschel mixer, homodisperser, colloid mixer, propeller-type stirrer, homodisperser, homogenizer, in-line type continuous emulsifier, ultrasonic emulsifier, vacuum kneader, or other mixing devices.

In order to accelerate a hydrosilation reaction of the cross-linkable silicone composition, the emulsion of the cross-linkable silicone composition may be heated. However, since heating impairs emulsion stability, it is preferable to conduct the hydrosilation reaction of the cross-linkable silicone composition at room temperature. There are no special restrictions with regard to the form in which the cross-linked silicone particles obtained from the cross-linkable silicone composition are produced, and the particles can be obtained as a rubber-like, gel-like, or a similar elastomeric cross-linked substance.

The following is a more detailed description of the cross-linkable silicone composition of the invention.

The cross-linkable silicone composition of the invention comprises at least the following components:

(I) 100 parts by mass of a silicone composition obtained by removing water from an emulsion of a silicone oil that contains cross-linked silicone particles in drops of a silicone oil which are dispersed in water and have an average diameter in the range of 0.1 to 500 μm, the aforementioned silicone oil comprising an organopolysiloxane containing in its molecule at least two alkenyl groups, the cross-linked silicone particles being obtained by means ofa hydrosilation reaction;

(II) 0.1 to 500 parts by mass of an organopolysiloxane that contains in its molecule at least two silicon-bonded hydrogen atoms; and

(III) a catalytic quantity of a hydrosilation catalyst.

Component (I) is a silicone oil composition obtained by removal of water from the aforementioned emulsion. As has been mentioned above, this silicone oil composition consists of cross-linked silicone particles and an organopolysiloxane containing in its molecule at least two alkenyl groups. The cross-linked silicone particles and an organopolysiloxane were described earlier.

There are no special limitations with regard to the method for removal of water from the emulsion, and water can be removed, e.g., by drying or heating the emulsion.

Component (II) is an organopolysiloxane that contains in its molecule at least two silicon-bonded hydrogen atoms. Silicon-bonded organic groups other than alkenyl groups of component (II) are represented by methyl groups, ethyl groups, propyl groups, or similar alkyl groups; phenyl groups, tolyl groups, xylyl groups, or similar aryl groups; benzyl groups, phenethyl groups, or similar aralkyl groups; 3,3,3-trifluoropropyl groups, or similar halogenated hydrocarbon groups. The methyl and phenyl groups are preferable. The organopolysiloxane of component (II) may have a linear, cyclic, net-like, or partially-branched linear molecular structure. Although there are no special limitations with regard to the viscosity of the component (II) at 25° C., it is preferred that the viscosity be within a range of 1 to 10,000 mPa·s.

It is recommended that component (II) be used in such an amount of 0.1 to 500 parts by mass per 100 parts by mass of component (I). If component (II) is used in an amount smaller than the recommended lower limit, it will be difficult to provide complete cross-linking of the obtained composition. If, on the other hand, component (II) is used in an amount greater than the upper recommended limit, this will cause unstable variations in physical properties of the obtained cross-linked silicone substances with time.

Component (III) is a hydrosilation reaction catalyst which is used for accelerating hydrosilation of components (I) and (II). This catalyst can be exemplified by a platinum-type catalyst, rhodium-type catalyst, and a palladium-type catalyst, of which the platinum-type catalyst is preferable. Such a platinum-type catalyst is represented by chloroplatinic acid, an alcoholic solution of chloroplatinic acid, an olefin complex of platinum, an alkenylsiloxane complex of platinum, platinum black, or silica that carries platinum.

It is preferred that component (III) be used in an amount sufficient for accelerating the hydrosilation reaction of components (I) and (II). For example, when a platinum-type catalyst is used as component (III), it should be used in an amount of 1×10⁻⁷ to 1×10⁻³ parts by mass of platinum metal per 100 parts by weight of the sum of components (I and (II).

To improve handling and workability of this cross-linkable composition, a curing inhibitor can be additionally combined with. The curing inhibitor can be exemplified by 2-methyl-3-butyn-2-ol, 3,5-dimethyl-1-hexyn-3-ol, 2-phenyl-3-butyn-2-ol, or similar alkyne alcohols; 3-methyl-3-penten-1-yne; 3,5-dimethyl-3-hexen-1-yne, or similar enyne compounds; another example is benzotriazole. Although there are no special restrictions with regard to the amounts in which the curing inhibitors can be added, it is recommended to add them in an amount of 10 to 50,000 ppm.

A filler can be added to the composition as an arbitrary component for improving mechanical strength of the obtained cross-linked silicone substances. Such a filler is exemplified by precipitated silica, fumed silica, baked silica, fumed titanium oxide, or a similar reinforcing filler; crushed quartz, diatomaceous earth, aluminosilicic acid, ferrous oxide, zinc oxide, calcium oxide, or a similar non-reinforcing filler. The surfaces of these fillers can be treated with hexamethylsilazane, trimethylchlorosilane, polydimethylsiloxane, polymethylhydridosiloxane, or similar organosilicon compounds.

### EXAMPLES

The emulsions of the invention, manufacturing methods thereof, and the cross-linkable silicone compositions of the invention will now be explained in more detail with reference to the following practical examples. In these examples, all values of viscosity were measured at 25° C. The following procedures were used for determining the average diameter of particles in the emulsion, the average diameter of cross-linked silicone particles, and various properties of cross-linked substances of the cross-linkable silicone composition.

[Average Diameter of Emulsion Particles]

The diameter of emulsion particles was measured with the use of a laser-diffraction type particle distribution measurement instrument of Horiba Seisakusho Co., model LA-500. The obtained median diameter (a particle diameter corresponding to 50% of the accumulated distribution) was defined as an average particle diameter. For practical example 1-2 and comparative example 1-2, the diameter of emulsion particles was shown in Table 1.

[Average Diameter of Cross-Linked Silicone Particles]

The emulsion was dried in an air flow on a glass plate, and then the average particle diameter was determined as the average value of the diameter of 10 particles measured under a stereoscopic microscope. For practical example 1-2 and comparative example 1-2, the diameter of cross-linked silicone particles was shown in Table 1.

[Hardness of Cross-Linked Product]

A cross-linked silicone product was obtained by heating a cross-linkable silicone composition in an oven for 65 minutes at 125° C. Hardness of the obtained cross-linked silicone substances was measured by a type A durometer in accordance with the procedure specified by JIS K 6253.

[Viscoelasticity of the Cross-Linked Product]

Two specimens (No. 1 and No. 2) of silicone cross-linked substances having a thickness of about 2.1 mm were prepared by heating the cross-linkable silicone composition in an oven for 65 minutes at 125° C., and the storage elastic modulus G′(×10³ dyne/cm² was measured by an ARES viscoelasticity measuring apparatus (Rheometric Scientific Company). The measurements were carried out at room temperature using 25 mm parallel plates, a gap of about 2.1 mm, a strain of 5%, a vibration frequency of 0.1 to 50 Hz, and a specimen compression force of 1000 g.

### Practical Example 1

A mixture was prepared from the following components: 17.78 parts by mass of a copolymer of methylhexenylsiloxane and dimethylsiloxane having 350 mPa·s viscosity and capped at both molecular terminals with dimethylhexenylsiloxy groups (hexenyl group content=0.91 mass %); 80 parts by mass of a dimethylpolysiloxane having a viscosity of 90 mPa·s and capped at both molecular terminals with dimethylvinylsiloxy groups; 2.22 parts by mass of a 47 mPa·s viscosity copolymer of a methylhydrogensiloxane and a dimethylsiloxane capped at both molecular terminals with trimethylsiloxy groups (content of silicon-bonded hydrogen atoms=0.31 mass %; the silicon-bonded hydrogen atoms contained in this component were used in an amount of 0.19 moles per 1 mole of the sum of vinyl groups of the dimethylpolysiloxane and hexenyl groups of the aforementioned copolymer of methylhexenylsiloxane and dimethylsiloxane); 0.5 parts by mass of polyoxyethylenealkylether (a product of Sanyo Chemical Industries Co., Ltd., Sannonic SS120), and 30 parts by mass of pure water. After emulsification, 58 parts by mass of pure water were added whereby an emulsion of a silicone composition was prepared.

A platinum-type catalyst comprising a 1,3-divinyl-1,1,3,3-tetramethyldisiloxane solution having a complex of platinum and 1,3-divinyl-1,1,3,3-tetramethyldisiloxane as its main component (average diameter of the platinum-system catalyst particles=0.05 μm; concentration of metallic platinum=0.05 mass %) was added to the obtained emulsion of the silicone composition, and the components were uniformly mixed so that in terms of mass units per content of the emulsion solids the content of metallic platinum in the cross-linkable silicone composition was equal to 20 ppm. As a result, an emulsion of the cross-linked composition with a content of water in the range of 49 to50 mass % was obtained.

The obtained emulsion was kept intact at room temperature for one day and subjected to a hydrosilation reaction, whereby there was prepared a silicone oil emulsion having cross-linked silicone particles of silicone oil drops dispersed in water.

The emulsion was then transferred to a 5 cm diameter aluminum plate, and water was removed from the emulsion by drying in air, while maintaining it in air flow for 1 week. As a result, a silicone oil composition consisting of cross-linked silicone particle and silicone oil was prepared. Moisture loss was verified by measuring loss of the original mass. After stirring the obtained silicone oil composition in a dental mixer, viscosity was measured by means of a rotary type viscometer. The viscosity value was 1,970 mPa·s. This silicone oil composition had a cream-like form and looks uniform. Observation of the composition under a stereoscopic microscope showed that it consisted of cross-linked silicone particles uniformly dispersed in the silicone oil. The cross-linked silicone particles were spherical in shape.

### Practical Example 2

A mixture was prepared from the following components: 98.5 parts by mass of a dimethylpolysiloxane having a viscosity of 90 mPa·s and capped at both molecular terminals with dimethylvinylsiloxy groups; 1.95 parts by mass of a copolymer of methylhydrogensiloxane and dimethylsiloxane having 47 mPa·s viscosity and capped at both molecular terminals with trimethylsiloxy groups (content of silicon-bonded hydrogen atoms=0.31 mass %; the silicon-bonded hydrogen atoms contained in this component were used in an amount of 0.20 moles per 1 mole of vinyl groups of the aforementioned dimethylpolysiloxane); 0.5 parts by mass of polyoxyethylenealkylether (a product of Sanyo Chemical Industries Co., Ltd., Sannonic SS120), and 30 parts by mass of pure water. After emulsification of said mixture, 58 parts by mass of pure water were added whereby an emulsion of a silicone composition was prepared.

A platinum-type catalyst comprising a 1,3-divinyl-1,1,3,3-tetramethyldisiloxane solution having a complex of platinum and 1,3-divinyl-1,1,3,3-tetramethyldisiloxane as its main component (average diameter of the platinum-type catalyst particles=0.05 μm; concentration of metallic platinum=0.05 mass %) was added to the obtained emulsion of the silicone composition, and the components were uniformly mixed so that in terms of mass units per content of the emulsion solids the content of metallic platinum in the cross-linkable silicone composition was equal to 20 ppm. As a result, an emulsion of the cross-linked composition with a content of water in the range of 49 to50 mass % was obtained.

The obtained emulsion was kept intact at room temperature for one day and subjected to a hydrosilation reaction, whereby there was prepared a silicone oil emulsion containing cross-linked silicone particles in silicone oil drops which were dispersed in water.

The emulsion was then transferred to a 5 cm diameter aluminum plate, and water was removed from the emulsion by drying in air, while maintaining it in air flow for 1 week. As a result, a silicone oil composition consisting of cross-linked silicone particle and silicone oil was prepared. Moisture loss was verified by measuring loss of the original mass. After stirring the obtained silicone oil composition in a dental mixer, the viscosity was measured by a rotary type viscometer. The viscosity value was 670 mPa·s. This silicone oil composition had a cream-like form and looked uniform. Observation of the composition under a stereoscopic microscope showed that it consisted of cross-linked silicone particles uniformly dispersed in the silicone oil. The cross-linked silicone particles were spherical in shape.

### Comparative Example 1

A mixture was prepared from the following components: 97.08 parts by mass of a dimethylpolysiloxane having a viscosity of 90 mPa·s and capped at both molecular terminals with dimethylvinylsiloxy groups; 2.92 parts by mass of a copolymer of methylhydrogensiloxane and dimethylsiloxane having 47 mPa·s viscosity and capped at both molecular terminals with trimethylsiloxy groups (content of silicon-bonded hydrogen atoms=0.31 mass %; the silicon-bonded hydrogen atoms contained in this component were used in an amount of 0.30 moles per 1 mole of vinyl groups of the aforementioned dimethylpolysiloxane); 0.5 parts by mass of polyoxyethylenealkylether (a product of Sanyo Chemical Industries Co., Ltd., Sannonic SS120), and 30 parts by mass of pure water. After emulsification of said mixture, 58 parts by mass of pure water were added whereby an emulsion of a silicone composition was obtained.

A platinum-type catalyst comprising a 1,3-divinyl-1,1,3,3-tetramethyldisiloxane solution having a complex of platinum and 1,3-divinyl-1,1,3,3-tetramethyldisiloxane as its main component (average diameter of the platinum-type catalyst particles=0.05 μm; concentration of metallic platinum=0.05 mass %) was added to the obtained emulsion of the silicone composition, and the components were uniformly mixed so that in terms of mass units per content of the emulsion solids the content of metallic platinum in the cross-linkable silicone composition was equal to 20 ppm. As a result, an emulsion of the cross-linked composition with a content of water in the range of 49 to50 mass % was obtained.

The obtained emulsion was kept intact at room temperature for one day and subjected to a hydrosilation reaction, whereby there was prepared a silicone oil emulsion having cross-linked silicone particles in silicone oil drops which were dispersed in water.

The emulsion was then transferred to a 5 cm diameter aluminum plate, and water was removed from the emulsion by drying in air, while maintaining it in air flow for 1 week. As a result, a silicone oil composition consisting of cross-linked silicone particle and silicone oil was prepared. Moisture loss was verified by measuring loss of the original mass. The silicone oil composition was obtained in the form of a non-flowable, tenacious, gel-like cross-linked solid substance.

### Comparative Example 2

A mixture was prepared from the following components: 90.27 parts by mass of a dimethylpolysiloxane having a viscosity of 90 mPa·s and capped at both molecular terminals with dimethylvinylsiloxy groups; 9.73 parts by mass of a copolymer of methylhydrogensiloxane and dimethylsiloxane having 47 mPa·s viscosity and capped at both molecular terminals with trimethylsiloxy groups (content of silicon-bonded hydrogen atoms=0.31 mass %; the silicon-bonded hydrogen atoms contained in this component were used in an amount of 0.95 moles per 1 mole of vinyl groups of the aforementioned dimethylpolysiloxane); 0.5 parts by mass of polyoxyethylenealkylether (a product of Sanyo Chemical Industries Co., Ltd., Sannonic SS120), and 30 parts by mass of pure water. After emulsification, 58 parts by mass of pure water were added whereby an emulsion of a silicone composition was produced.

A platinum-type catalyst comprising a 1,3-divinyl-1,1,3,3-tetramethyldisiloxane solution having a complex of platinum and 1,3-divinyl-1,1,3,3-tetramethyldisiloxane as its main component (average diameter of the platinum-system catalyst particles=0.05 μm; concentration of metallic platinum=0.05 mass %) was added to the obtained emulsion of the silicone composition, and the components were uniformly mixed so that in terms of mass units per content of the emulsion solids the content of metallic platinum in the cross-linkable silicone composition was equal to 20 ppm. As a result, an emulsion of the cross-linked composition with a water content in the range of 49 to 50 mass % was obtained.

The obtained emulsion was kept intact at room temperature for one day and subjected to a hydrosilation reaction, whereby a suspension of cross-linked silicone particles was produced.

The suspension was then transferred to a 5 cm diameter aluminum plate and water was removed from the suspension by drying it for 1 week in air flow. The obtained dry substance comprised silicone rubber particles that did not contain silicone oil.

TABLE 1

| | Practical. | Practical. | Comparative. | Comparative. |
|---|---|---|---|---|
| | Example. 1 | Example. 4 | Example. 1 | Example. 2 |
| Emulsion | 4.9 | 3.7 | 3.7 | 4.5 |
| average | | | | |
| particle | | | | |
| diameter | | | | |
| (μm) | | | | |
| Average | about 4 | about 3 | about 3 | about 4 |
| diameter | | | | |
| of cross- | | | | |
| linked | | | | |
| silicone | | | | |
| particle | | | | |
| (μm) | | | | |

### Practical Example 3

A hydrosilation-curable silicone rubber composition was prepared by mixing the following components: 100 parts by mass of the silicone oil composition prepared in Practical Example 1; 4.44 parts by mass of a copolymer of methylhydrogensiloxane and dimethylsiloxane which was capped at both molecular terminals with trimethylsiloxy groups and had a viscosity of 5 mPa·s (content of silicon-bonded hydrogen atoms=0.75 mass %; a platinum-type catalyst comprising a 1,3-divinyl-1,1,3,3-tetramethyldisiloxane solution having a complex of platinum and 1,3-divinyl-1,1,3,3-tetramethyldisiloxane as its main component (in terms of weight units, the content of metallic platinum in the composition was 5 ppm); and 2-phenyl-3-butyn-2-ol (content of this component in the composition in terms of weight units was 50 ppm). Results of measurement of hardness and viscoelastic properties of the cured silicone rubber obtained by cross-linking the composition are shown in Table 2.

### Practical Example 4

A hydrosilation-curable silicone rubber composition was prepared by mixing the following components: 100 parts by mass of the silicone oil composition prepared in Practical Example 2; 4.64 parts by mass of a copolymer of methylhydrogensiloxane and dimethylsiloxane which was capped at both molecular terminals with trimethylsiloxy groups and had a viscosity of 5 mPa·s (content of silicon-bonded hydrogen atoms=0.75 mass %; a platinum-type catalyst comprising a 1,3-divinyl-1,1,3,3-tetramethyldisiloxane solution having a complex of platinum and 1,3-divinyl-1,1,3,3-tetramethyldisiloxane as its main component (in terms of weight units, the content of metallic platinum in the composition was 5 ppm); and 2-phenyl-3-butyn-2-ol (content of this component in the composition in terms of weight units was 50 ppm). Results of measurement of hardness and viscoelastic properties of the cured silicone rubber obtained by cross-linking the composition are shown in Table 2.

### Comparative Example 3

A hydrosilation-curable silicone rubber composition was prepared by mixing the following components: 100 parts by mass of a dimethylpolysiloxane which was capped at both molecular terminals with dimethylsiloxy groups and had a viscosity of 90 mPa·s; 5.58 parts by mass of a copolymer of methylhydrogensiloxane and dimethylsiloxane which was capped at both molecular terminals with trimethylsiloxy groups and had a viscosity of 5 mPa·s (content of silicon-bonded hydrogen atoms =0.75 mass %); a platinum-type catalyst comprising a 1,3-divinyl-1,1,3,3-tetramethyldisiloxane solution having a complex of platinum and 1,3-divinyl-1,1,3,3-tetramethyldisiloxane as its main component (in terms of weight units, the content of metallic platinum in the composition was 5 ppm), and 2-phenyl-3-butyn-2-ol (content of this component in the composition in terms of weight units was 50 ppm). Results of measurement of hardness and viscoelastic properties of the cured silicone rubber obtained by cross-linking the composition are shown in Table 2.

### Comparative Example 4

A hydrosilation-curable silicone rubber composition was prepared by mixing the following components: 100 parts by mass of the silicone rubber particles obtained in Comparative Example 2; 4.46 parts by mass of a copolymer of methylhydrogensiloxane and dimethylsiloxane which was capped at both molecular terminals with trimethylsiloxy groups and had a viscosity of 5 mPa·s (content of silicon-bonded hydrogen atoms=0.75 mass %); a platinum-type catalyst comprising a 1,3-divinyl-1,1,3,3-tetramethyldisiloxane solution having a complex of platinum and 1,3-divinyl-1,1,3,3-tetramethyldisiloxane as its main component (in terms of weight units, the content of metallic platinum in the composition was 5 ppm); and 2-phenyl-3-butyn-2-ol (content of this component in the composition in terms of weight units was 50 ppm). Results of measurement of hardness and viscoelastic properties of the cured silicone rubber obtained by cross-linking the composition are shown in Table 2.

TABLE 2

| | Practical. | Practical. | | |
|---|---|---|---|---|
| | Example. | Example. | Comparative. | Comparative. |
| | 3 | 4 | Example. 3 | Example. 4 |
| Type A | 32 | 32 | 37 | 37 |
| durometer | | | | |
| hardness | | | | |
| G′ of No. 1 | 1313 | 1688 | 1799 | 2877 |
| (10³ dyne/cm²) | | | | |
| G′ of No. 2 | 1151 | 1500 | 1839 | 1417 |
| (10³ dyne/cm²) | | | | |
| Difference in | 162 | 188 | 40 | 1460 |
| G′ between | | | | |
| No. 1 and | | | | |
| No. 2 | | | | |

As can be seen from the results of Practical Examples 3 and 4, mixing of the silicone oil composition obtained from the emulsion of the invention with components of a silicone rubber composition or with additives makes it possible to obtain a soft and homogeneous silicone rubber. On the other hand, as can be seen from Comparative Example 4, measurements of the storage elastic modules show a significant difference between two specimens and therefore, it is understood that in this case it is impossible to provide uniform dispersion of cross-linked silicone particles in the specimens.

### INDUSTRIAL APPLICABILITY

Since the emulsion of the present invention is one that contains cross-linked silicone particles in droplets of silicone oil dispersed in water, and since the aforementioned silicone oil comprises an organopolysiloxane that contains at least two alkenyl groups in its molecule, the silicone oil composition obtained by removing water from the emulsion can be used as a starting material of a hydrosilation curable silicone rubber composition. Furthermore, since the aforementioned silicone oil constitutes the main component of the cross-linkable silicone composition of the invention, and since cross-linking of the composition by hydrosilation produces a cross-linked silicone substances with uniform distribution of cross-linked silicone particles, the composition can be used for manufacturing silicone rubber sheet, silicone rubber rollers, or the like.

1. An emulsion of a silicone oil that comprises cross-linked silicone particles in drops of a silicone oil which are dispersed in water and have an average diameter in the range of 0.1 to 500 μm, wherein the silicone oil is an organopolysiloxane having in its molecule at least two alkenyl groups, and wherein the cross-linked silicone particles are formed by a hydrosilation reaction.

2. The emulsion according to claim 1, wherein the silicone oil is an organopolysiloxane having in its molecule at least two alkenyl groups, and wherein the cross-linked silicone particles are obtained by subjecting the organopolysiloxane having in its molecule at least two alkenyl groups and an organopolysiloxane having in its molecule at least two silicon-bonded hydrogen atoms to hydrosilation in the presence of a hydrosilation catalyst.

3. A method of manufacturing an emulsion of a silicone oil that comprises silicone oil particles in silicone oil drops dispersed in water and having an average diameter in the range of 0.1 to 500 μm, the method comprising the steps of: subjecting an organopolysiloxane (A) having in its molecule at least two alkenyl groups and an organopolysiloxane (B) having in its molecule at least two silicon-bonded hydrogen atoms to a hydrosilation reaction in the presence of a hydrosilation catalyst (C), the silicon-bonded hydrogen atoms of component (B) being used in an amount of 0.05 to 0.3 moles per one mole of alkenyl groups contained in component (A).

4. A cross-linkable silicone composition of the invention that comprising at least the following components:
(I) 100 parts by mass of a silicone oil composition obtained by removing water from an emulsion of a silicone oil that contains cross-linked silicone particles in drops of a silicone oil which are dispersed in water and have an average diameter in the range of 0.1 to 500 μm, the silicone oil comprising an organopolysiloxane containing in its molecule alkenyl groups and the cross-linked silicone particles being obtained by means of a hydrosilation reaction;
(II) 0.1 to 500 parts by mass of an organopolysiloxane that contains in its molecule at least two silicon-bonded hydrogen atoms; and
(III) a catalytic quantity of a hydrosilation catalyst.

5. The emulsion according to claim 1, wherein the average diameter of the drops of silicone oil is 0.5 to 200 μm.

6. The method according to claim 3, wherein the average diameter of the drops of silicone oil is 0.5 to 200 μm.

7. The cross-linkable silicone composition according to claim 4, wherein the average diameter of the drops of silicone oil is 0.5 to 200 μm.

8. The emulsion according to claim 1, wherein the organopolysiloxane has a viscosity of 1 to 100,000,000 mPa·s at 25° C.

9. The emulsion according to claim 1, wherein the organopolysiloxane has a viscosity of 2 to 10,000,000 mPa·s at 25° C.
